(19) United States
(12) Patent Application Publication
(10) Pub. No.: US 2024/0104642 A1
(43) Pub. Date: Mar. 28, 2024

(54) APPARATUS FOR PROCESSING NON-FUNGIBLE TOKEN

(71) Applicant: Dunamu Inc., Seoul (KR)

(72) Inventors: Sanghoon KANG, Hanam-si (KR); Seungwon KANG, Seoul (KR)

(73) Assignee: Dunamu Inc., Seoul (KR)

(21) Appl. No.: 18/474,705

(22) Filed: Sep. 26, 2023

(30) Foreign Application Priority Data
Sep. 28, 2022 (KR) 10-2022-0123178

(51) Int. Cl. G06Q 30/0645; H04L 9/00

(52) U.S. Cl. CPC G06Q 30/0645; H04L 9/50

(57) ABSTRACT

Provided is an electronic device including a communication interface, one or more memories, and one or more processors configured to receive, from a user terminal of a user, a rental request for a digital asset corresponding to a first token, and to perform a procedure of generating a second token based on the rental request. The first token is generated based on a first smart contract configured to prove ownership of the digital asset, and first metadata of the first token indicates an owner having the ownership of the digital asset. The second token is generated based on a second smart contract configured to prove a right of use of the digital asset, and second metadata of the second token indicates a person having the right of use of the digital asset. Generation information of the second token indicating a rental history of the digital asset is recorded in the first metadata of the first token.

### CROSS-REFERENCE TO RELATED APPLICATIONS

This application claims benefit of priority under 35 U.S.C. § 119 to Korean Patent Application No. 10-2022-0123178, filed on Sep. 28, 2022, in the Korean Intellectual Property Office, the disclosure of which is incorporated by reference herein in its entirety.

### BACKGROUND

### 1. Field

The present disclosure relates generally to non-fungible tokens, and more particularly, to apparatuses and methods for processing non-fungible tokens.

### 2. Description of Related Art

Heritage of a product may refer to a long tradition of the product and/or a history of the product, and formation of the heritage of the product may be used as a marketing strategy that may increase the value of the product.

Recently, as interest in the metaverse (e.g., an expanded virtual world) may have increased, interest in digital assets that may be used to express a unique personality of a person within the metaverse may also increase. Consequently, interest in non-fungible tokens that may be used to prove the originality of the digital assets (e.g., ownership, heritage) may also increase.

### SUMMARY

Aspects of the present disclosure provide for potentially increasing a value of a non-fungible token by guaranteeing a digital asset.

Aspects the present disclosure provide for representing a usage history of the digital asset through the non-fungible token guaranteeing the digital asset.

Aspects of the present disclosure provide a platform for renting the digital asset.

Aspects of the present disclosure provide for proving a right to use the digital asset according to renting of the digital asset.

According to an aspect of the present disclosure, an electronic device is provided. The electronic device includes a communication interface configured to communicate with at least one node of a blockchain network and an external device. The electronic device further includes one or more memories configured to store at least one instruction, and one or more processors communicatively coupled to the communication interface and to the one or more memories. The one or more processors are configured to execute the at least one instruction to receive, from a user terminal of a user, a rental request for a digital asset corresponding to a first token, and to perform a procedure of generating a second token based on the rental request. The first token is generated based on a first smart contract configured to prove ownership of the digital asset, and first metadata of the first token indicates an owner having the ownership of the digital asset. The second token is generated based on a second smart contract configured to prove a right of use of the digital asset, and second metadata of the second token indicates a person having the right of use of the digital asset. Generation information of the second token indicating a rental history of the digital asset is recorded in the first metadata of the first token, based on generation of the second token.

In some embodiments, the one or more processors may be further configured to receive, from the user terminal of the user, a usage log indicating a usage history of the digital asset and to perform a recording procedure of recording the usage log of the first token in the first metadata of the first token, based on receiving the usage log. The recording procedure comprises an operation of transmitting, to the at least one node of the blockchain network, a recording request requesting to execute the first smart contract.

In some embodiments, the second metadata of the second token may further indicate a rental period of the digital asset. In such embodiments, the one or more processors may be further configured to perform the recording procedure of recording the usage log of the first token based on whether a time point at which the recording request is transmitted is within the rental period.

In some embodiments, virtual assets corresponding to at least a portion of virtual assets recorded in the first token are transmitted to a wallet address of the person having the right of use, based on the recording request.

In some embodiments, the usage log may include at least one of information on the person having the right of use, information on content using the digital asset, information on an aspect of using the digital asset, or information on a time point at which the digital asset is used.

In some embodiments, the one or more processors may be further configured to receive, from an external terminal distinguished from the user terminal, a verification request for the second token, to compare the second metadata of the second token with information recorded in a block corresponding to the second token based on the verification request, and to transmit, to the external terminal, based on the second metadata of the second token matching the information recorded in the block, at least one of a first address of the first token, a second address of the second token, an identifier of the second token, a signature of the person having the right of use, or a temporary value. The temporary value is a randomly changed value based on reception of the verification request.

In some embodiments, based on the second metadata of the second token matching the information recorded in the block, information indicating the usage history of the digital asset is recorded in the first metadata of the first token as the usage log.

In some embodiments, a representative image of the first token is determined as one of a plurality of sub digital assets included by the digital asset, based on at least one of a first number of the usage log recorded in the first metadata of the first token or a second number of the generation information.

In some embodiments, the representative image of the first token is determined as one of the plurality of sub digital assets included by the digital asset, based on at least one of a first weighted sum of the first number and a usage period corresponding to the first number or a second weighted sum of the first number and a rental period corresponding to the first number.

In some embodiments, the one or more processors may be further configured to determine a representative image indicating the first token is determined as one of a plurality of sub digital assets included by the digital asset, based on whether at least one of the usage log recorded in the first metadata of the first token or the generation information satisfies a predetermined condition. In such embodiments, the predetermined condition may be related to at least one of information on the owner or the person having the right of use of the digital asset included by at least one of the usage log or the generation information, information on content related to the use of the digital asset, or information on an aspect of using the digital as set.

In some embodiments, the one or more processors may be further configured to perform the procedure of generating the second token based on an interaction with the at least one node of the blockchain network.

In some embodiments, the second metadata of the second token may further indicate whether the digital asset is allowed to be subleased.

In some embodiments, the generation information may include at least one of information on a rental period of the digital asset, information on the person having the right of use, information on content scheduled to use the digital asset, information on an expected usage aspect of the digital asset, or information on a time point at which the digital asset is scheduled to be used.

In some embodiments, the rental request is accompanied with an operation of transmitting to a wallet address of the electronic device, a virtual asset corresponding to a price for rental of the digital asset, based on receiving the rental request.

In some embodiments, the virtual asset are recorded in the first metadata of the first token, based on generation of the second token. In such embodiments, the one or more processors may be further configured to receive, from a user terminal of the owner of the digital asset, a withdrawing request requesting to withdraw the virtual asset from the first token, and to transmit, to the at least one node of the blockchain network, a transmit message requesting to transmit at least a portion of the virtual asset to a wallet address of the owner, based on the withdrawing request.

In some embodiments, the one or more processors may be further configured to receive, from the user terminal of the user, a transfer request requesting to transfer the second token, and to transmit, to the at least one node of the blockchain network, a change message requesting to change information indicating the person having the right of use of the second token, based on the transfer request.

In some embodiments, the second metadata of the second token may further indicate a rental period of the digital asset. In such embodiments, the one or more processors may be further configured to change information indicating the person having the right of use of the second token based on whether the rental period has lapsed.

In some embodiments, the first smart contract may include information for generating the second token including rental information of the digital asset as metadata. The rental information of the digital asset may indicate the person having the right of use of the digital as set.

According to an aspect of the present disclosure, a method performed by an electronic device is provided. The method includes receiving, from a user terminal of a user, a rental request for a digital asset corresponding to a first token, and performing a procedure of generating, based on the rental request, a second token. The first token is generated based on a first smart contract configured to prove ownership of the digital asset, and first metadata of the first token indicates an owner having the ownership of the digital asset. The second token is generated based on a second smart contract configured to prove a right of use of the digital asset, and second metadata of the second token indicates a person having the right of use of the digital asset. Generation information of the second token indicates a rental history of the digital asset is recorded in the first metadata of the first token, based on the generating of the second token.

In some embodiments, the method may further include receiving, from the user terminal of the user, a usage log indicating a usage history of the digital asset and performing a recording procedure of recording the usage log of the first token in the first metadata of the first token, based on the receiving of the usage log The recording procedure comprises an operation of transmitting, to at least one node of a blockchain network, a recording request requesting to execute the first smart contract.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 illustrates an environment to which devices may be applied, according to an embodiment of the present disclosure;

FIG. 2 illustrates a computing device for implementing a device, according to an embodiment of the present disclosure;

FIG. 3 is a flowchart illustrating an asset token generation method, according to an embodiment of the present disclosure;

FIG. 4 illustrates an asset token, according to an embodiment of the present disclosure;

FIG. 5 is a flowchart illustrating a method of generating a token for a right to use, according to an embodiment of the present disclosure;

FIG. 6 illustrates the token for the right to use, according to an embodiment of the present disclosure;

FIG. 7 is a flowchart illustrating a method of recording a usage log, according to an embodiment of the present disclosure;

FIG. 8 is a flowchart illustrating a method of withdrawing a virtual asset through an asset token, according to an embodiment of the present disclosure;

FIG. 9 is a flowchart illustrating a method of verifying the token for the right to use, according to an embodiment of the present disclosure; and

FIG. 10 is a flowchart illustrating a method of transferring the token for the right to use, according to an embodiment of the present disclosure.

### DETAILED DESCRIPTION

Various embodiments of the present disclosure are only examples to clearly describe the technical idea of the present disclosure and do not intend to limit the same to specific forms. The technical idea of the present disclosure may include various modifications, equivalents, and/or alternatives of respective embodiments disclosed in the present disclosure, and/or an embodiment selectively combined from all or some of the respective embodiments. The scope of the technical idea of the present disclosure may not be limited to various embodiments presented hereinafter and/or the detailed description thereof.

The terms including technical or scientific terms used in the present disclosure may have meanings generally understood by those skilled in the technical field to which the present disclosure belongs unless specifically defined.

The expressions “include,” “may include,” “provided with,” “may be provided with,” “have,” “may have,” and the like used in the present disclosure may indicate the existence of features subject thereto (e.g., functions, operations, elements, or the like) and may not exclude the existence of other additional features. That is, the expressions should be understood as open-ended terms connoting the possibility of inclusion of other embodiments.

A singular expression used in the present disclosure may include meanings of plurality, unless otherwise mentioned in context, and the same may be applied to a singular expression recited in the claims.

The expressions “first,” “second,” and the like used in the present disclosure may be used to distinguish a plurality of components from each other, unless otherwise mentioned in context, and may not be intended to limit the order or importance of the relevant components. For example, respective user terminals included in a plurality of user terminals according to the present disclosure may be distinguished from each other through expressions of “first user terminal” and “second user terminal.” Further, a plurality of tokens according to the present disclosure may be distinguished from each other through expressions of “first token” and “second token.”

The expressions “A, B, and C,” “A, B, or C,” “at least one of A, B, and C,” and “at least one of A, B, or C” used in the present disclosure may include each of the listed items or all available combinations of the listed items. For example, “at least one of A and B” may refer to (1) at least one A, (2) at least one B, or (3) both of at least one A and at least one B.

The expression “based on” used in the present disclosure may be used to describe one or more factors that may influence a decision, an action of judgment, and/or an operation described in a phrase or sentence including the relevant expression. This expression may not exclude additional factors influencing the decision, the action of judgment, and/or the operation.

The expression indicating that any element (e.g., a first element) is “connected to” or “coupled to” another element (e.g., a second element) may not only indicate that the any element is directly connected or coupled to the other element but may also indicate that the any element is connected or coupled thereto via a new element (e.g., a third element).

The expression “configured to” used in the present disclosure may have a meaning such as “set to,” “having an ability to,” “changed to,” “made to,” “capable of,” or the like in context. That is, the expression may not be limited to a meaning of “specially designed in hardware.” For example, a processor configured to perform a particular operation may be a generic purpose processor capable of performing the particular operation by executing software and/or may be a special purpose computer structured through programming to perform the particular operation.

The embodiments herein may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

The term “digital asset” used in the present disclosure may refer to pieces of data which may be expressed in a binary form and may be used as an asset. The digital asset may be, for example, a character, a two-dimensional image, a three-dimensional image, a video, polygon graphics, or the like. More specifically, the digital asset may be a character, a two-dimensional image, a three-dimensional image, a video, polygon graphics, or the like for clothes, bags, accessories, furniture, vehicles, buildings, property, game items, digital cards, or the like. In various embodiments disclosed in the present disclosure, the digital asset may be traded as a valuable asset between owners and/or people having the right of use and/or may be used within various pieces of content by owners and/or people having the right of use. Alternatively or additionally, in various embodiments, originality of the digital asset may be secured by a non-fungible token corresponding to the digital asset.

The term “token” used in the present disclosure may refer to a token which may be used in a blockchain managed by a blockchain network and may be a non-fungible token. Hereinafter, an object simply referred to as a token in the present disclosure may be a non-fungible token unless otherwise specified in context.

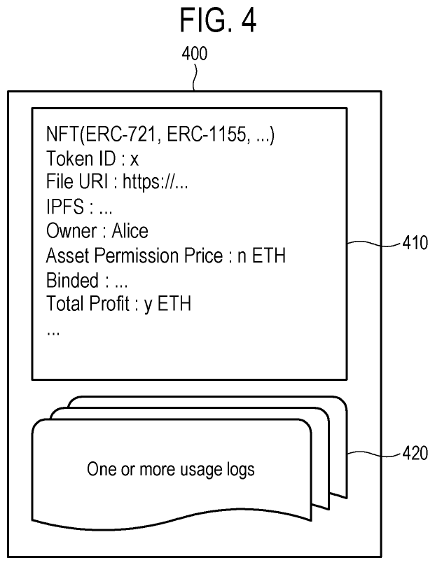

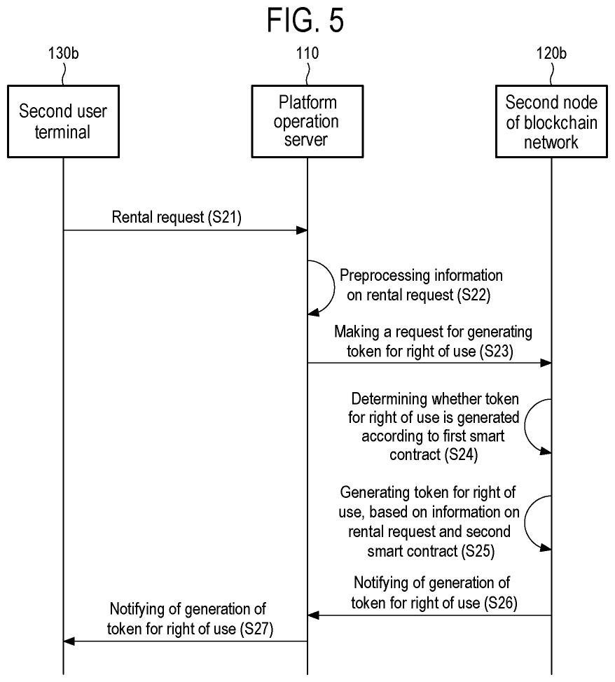

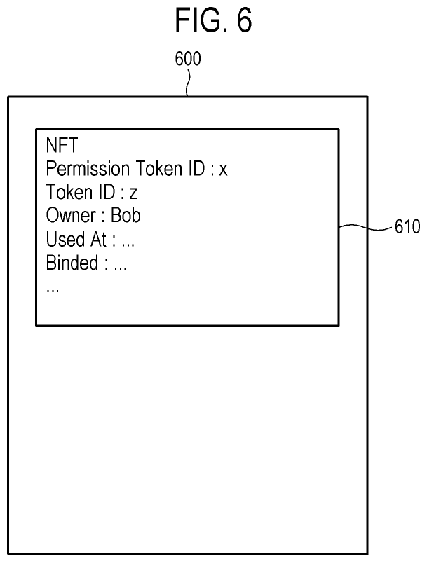

In an embodiment, the token may be and/or may include a set of pieces of data including a specific type of data. In an embodiment, the token may include, but not be limited to, at least one piece of information for accessing a digital asset connected to the token (hereinafter, referred to as a digital asset uniform resource identifier (URI)), information for accessing metadata of the token (hereinafter, referred to as a metadata URI), and information of an owner of the token (e.g., an address of a node of the owner in the blockchain, hereinafter referred to as information indicating the owner). In an optional or additional embodiment, the token may further include a digital asset connected to the token and/or metadata of the token. The digital asset URI connected to the token may be and/or may include an address of a centralized server and/or a cloud server that may store the digital asset. Alternatively or additionally, the digital asset URI may be a hash value (e.g., “ipfs.io/ipfs/12345678”) of the digital asset stored in an interplanetary file system (IPFS) that may store files in a distributed manner across several devices. The metadata URI of the token may be and/or may include an address of a centralized server and/or a cloud server that may store metadata of the token. Alternatively or additionally, the metadata URI of the token may be and/or may include a hash value of the metadata stored in the IPFS. The metadata of the token may refer to a set of data including various pieces of information on the token. The metadata may include, but not be limited to, at least one of, for example, a token name, token identification information (token ID), a name of a specific object associated with the token, a time point at which the token is generated, information of a current owner of the token, a history of changes in the token owner, and information for accessing the digital asset connected to the token (e.g., the digital asset URI). An example of expressing predetermined metadata in a JavaScript object notation (JSON) format is described with reference to FIG. 4 or FIG. 6. Hereinafter, the expression “first information of the token,” “first information recorded in the token,” “first information included in the token,” or the like may be understood as the expression “first information included (or recorded) in metadata of the token”.

The term “smart contract” used in the present disclosure may refer to a program and/or an application executed on a virtual machine operated by one or more nodes included in the blockchain network. The smart contract may be written to comply with one or more fixed regulations or protocols. For example, the smart contract may be made to include, but not be limited to, one or more functions corresponding to Ethereum Request for Comment 20 (ERC-20), ERC-721, ERC-1155, or the like. However, various types of smart contracts may be written by including other functions which may not be included in the above-described protocols in the smart contracts.

The term “usage log” used in the present disclosure may refer to a record indicating a usage history of the digital asset when the digital asset is used in the content. For example, the “usage log” may include, but not be limited to, at least one piece of information on an owner of the digital asset and/or a person having the right of use who uses the digital asset, information on the content in which the digital asset is used, information on a usage aspect of the digital asset, and information on a time point at which the digital asset is used. The content may be and/or may include a sign, a character, a figure, a color, a voice, a sound, an image, a video, or a combination thereof. Alternatively or additionally, the content may be and/or may include, for example, a movie, a soap opera, a game, an audio clip, a video clip, and the like. The usage aspect of the digital asset may be and/or may include a comprehensive look, form, deployment, or the like of the displayed digital asset when the digital asset is used in the content. For example, the usage aspect may be and/or may include an image, audio, or the like within the content when the digital asset is used.

The usage aspect may include dynamic changes in the digital asset according to an interaction with another object within the content. For example, when the digital asset is used for a movie, the usage log may include a title of the movie, a scene using the digital asset, a location and/or a period on a timeline of the entire movie of the scene, a date on which the digital asset is used for the movie, and the like. As another example, when the digital asset is used for a game, the usage log may include a title of the game, a location of the digital asset on a map of the game, a date on which the digital asset is used for the game, a list of game accounts using the digital asset, and the like. As yet another example, when the digital asset is used for the metaverse, the usage log may include a name of a platform, a list of user accounts of the platform using the digital asset, a location of the digital asset within the metaverse, a data on which the digital asset is used for the metaverse, and the like. In addition to the above-described examples, digital assets which may be recorded in the form of character strings and/or images may be included in the usage log.

The term “sublease” used in the present disclosure may refer to an action of renting the digital asset for another use by another user borrowing the digital asset (e.g., a person having the right of use of the digital asset). Since the renting of the digital asset according to the present disclosure is based on a token for the right of use, the sublease may be implemented by, for example, changing information indicating the person having the right of use included in metadata of the token for the right to use.

Hereinafter, various embodiments disclosed in the present disclosure are described with reference to the accompanying drawings. In the accompanying drawings and description of the drawings, the same reference numeral may be assigned to the same or substantially equivalent elements. Further, in description of various embodiments below, overlapping description of the same or corresponding element may be omitted, but it does not mean that the element is not included in the embodiments.

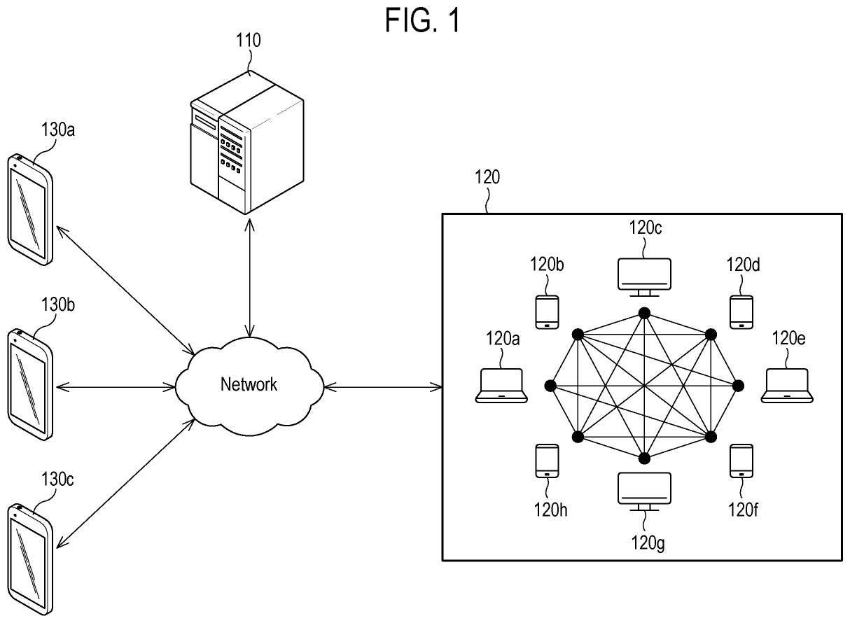

FIG. 1 illustrates an environment to which devices may be applied according to an embodiment of the present disclosure. The environment may include a platform operation server 110, a blockchain network 120 including a plurality of nodes (e.g., first node 120a, second node 120b, third node 120c, fourth node 120d, fifth node 120e, sixth node 120f, seventh node 120g, and eighth node 120h), and one or more user terminals (e.g., first user terminal 130a, second user terminal 130b, and third user terminal 130c, hereinafter generally referred to as “130”). FIG. 1 illustrates an example in which the one or more user terminals 130 and the plurality of nodes 120a to 120h are connected to the platform operation server 110 through the network 140. However, the illustration is provided for convenience of understanding and is not intended to limit the present disclosure. That is, the number of user terminals and the number of nodes may vary (e.g., increase, decrease) without departing from the scope of the present disclosure.

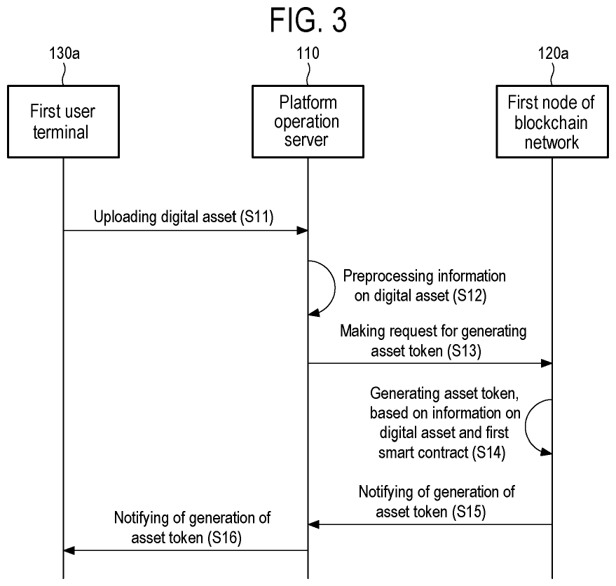

The platform operation server 110 may be and/or may include a server which may implement a platform to support transactions of the digital asset on the basis of the non-fungible token. The platform operation server 110 may be and/or may include a device associated with a subject operating the platform. The platform operation server 110 may perform various functions and/or operations for the non-fungible token associated with the digital asset to support transactions of the digital asset. For example, the platform operation server 110 may receive the digital asset from the first user terminal 130a and perform a procedure of generating a token (e.g., an asset token) for proving ownership of the digital asset. As another example, the platform operation server 110 may receive a request for renting the digital asset from the second user terminal 130b and perform a procedure of generating a token (e.g., a token for the right of use) for proving the right of use of the digital asset. In the above-described examples, the generation procedure may include an operation in which the platform operation server 110 transmits a generation request to at least one node 120a to 120h included in the blockchain network 120. The generation procedure is further described with reference to FIGS. 3 and 5.

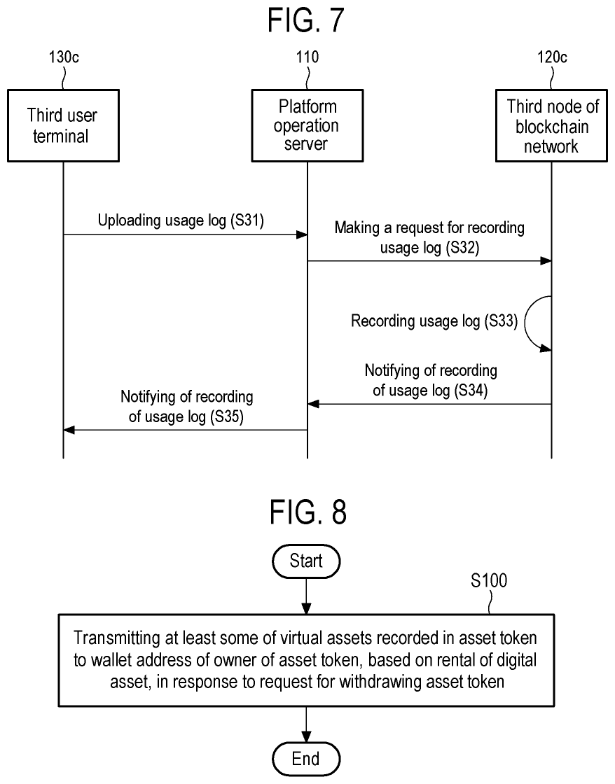

In an embodiment, the platform operation server 110 may receive a usage log of the digital asset from the third user terminal 130c and perform a record procedure of recording the usage log in metadata of the token (e.g., the asset token) corresponding to the digital asset. In the above-described example, the record procedure may include an operation in which the platform operation server 110 transmits a record request to at least one node 120a to 120h included in the blockchain network 120. In an embodiment, the at least one node 120a to 120h receiving the record request may record the usage log in a webpage of a link (e.g., an uniform record locator (URL) linked to an external webpage) included in metadata of the asset token. The record procedure is further described with reference to FIG. 7.

In an embodiment, the platform operation server 110 may perform various operations necessary for a transaction platform of the digital asset based on the non-fungible token. For example, the platform operation server 110 may store and/or manage the tokens (e.g., asset tokens and/or tokens for the right of use) received from the user terminals 130 and provide users of the user terminals 130 with a user interface (UI) for managing the tokens. Alternatively or additionally, the platform operation server 110 may perform a purchasing procedure and/or a selling procedure of the token according to a request for purchasing and/or selling the token from a user terminal 130. That is, the platform operation server 110 may perform platform operations of relaying transactions and/or requests between a purchaser and a seller of the token. In an embodiment, a virtual asset may be needed as a benefit in return for the token in order to initiate the purchasing procedure and/or the selling procedure of the token performed by the platform operation server 110. For example, the token may be transferred from a wallet address of the seller to a wallet address of the purchaser according to the purchasing procedure and/or the selling procedure performed by the platform operation server 110.

Alternatively or additionally, the platform operation server 110 may be involved in generating the token and/or recording the usage log by interacting with the plurality of nodes 120a to 120h included in the blockchain network 120.

In an embodiment, the platform operation server 110 may be implemented as one or more computing devices. For example, the functions of the platform operation server 110 may be implemented in a single computing device. As another example, a first function of the platform operation server 110 may be implemented in a first computing device, and a second function, different from the first function, may be implemented in a second computing device that may be different from the first computing device. The computing device may be and/or may include a desktop, a laptop, an application server, a proxy server, a cloud server, or the like. However, the present disclosure is not limited thereto and the computing device may include other types of devices having a computing function.

The blockchain network 120 may include a plurality of nodes 120a to 120h that may manage the blockchain. In an embodiment, a block may refer to a specific document type. In an optional or additional embodiment, the blockchain may refer to a document structure in which one or more blocks may be connected in a chain form. For example, the one or more blocks included in the blockchain may be independently stored in the plurality of nodes 120a to 120h included in the blockchain network 120. Alternatively or additionally, the one or more blocks may be stored in a distributed manner across several nodes of the plurality of nodes 120a to 120h. Each of the one or more blocks may include, but not be limited to, a block hash, a block header, or a block body. The block hash may be and/or may include unique information for identifying a block. For example, the block hash may be a character string expressed in 256 bits. The block header may be and/or may include, but not be limited to, at least one of version information of software and/or protocol, a hash of a previous block according to the block connection order in the blockchain, a Merkle Root, time information indicating a time at which the block is generated, bits indicating a level of difficulty of calculations, or Nonce corresponding to a value required for mining that may add a new block to the blockchain. The block body may be and/or may include at least one transaction. The transaction may be and/or may include a set of data having a specific document structure and/or may be a unit of information stored in the block body. The transaction may include information on the generation and/or transaction of the token. For example, the transaction may be and/or may include information containing content indicating information such as, but not limited to, that the first node 120a included in the blockchain network 120 transmits the token to the second node 120b. As another example, the transaction may be and/or may include information containing content indicating information such as, but not limited to, that the first node 120a included in the blockchain network 120 transmits the non-fungible token to the second node 120b.

Each of the plurality of nodes 120a to 120h included in the blockchain network 120 may be referred to as a participant of the blockchain network 120. In an embodiment, at least one node 120a to 120h included in the blockchain network 120 may be operated by a hierarchical structure. The hierarchical structure may be and/or may include, for example, at least one of a data layer for defining the structure of data handled by the blockchain network 120 and managing the data, a settlement layer for verifying validity of the block, performing mining to generate a block, and processing fees paid to a miner during the mining process, a common layer for implementing or managing a peer-to-peer (P2P) network protocol, a hash function, an electronic signature, encoding, and a common repository, and/or an application layer for generating or processing various applications.

At least one node 120a to 120h included in the blockchain network 120 may share and/or store transactions recorded in the blockchain. Alternatively or additionally, at least one node 120a to 120h included in the blockchain network 120 may verify transactions transmitted to the blockchain network 120 through a consensus algorithm of the blockchain and perform a function of recording the verified transaction in one block of the blockchain when the verification is completed. The consensus algorithm performed by the blockchain network 120 may include, but not be limited to, at least one of a proof of work (PoW) algorithm, proof of stake (PoS) algorithm, a delegated proof of stage (DPoS) algorithm, a practical Byzantine fault tolerance (PBFT) algorithm, a delegated Byzantine fault tolerance (DBFT) algorithm, a redundant Byzantine fault tolerance (RBFT) algorithm, a Sieve algorithm, a Tendermint algorithm, a Paxos algorithm, a Baft algorithm, a proof of authority (PoA) algorithm, a proof of elapsed time (PoET) algorithm, and the like.

Each of at least one node 120a to 120h included in the blockchain network 120 may store the smart contract. Accordingly, at least one node 120a to 120h included in the blockchain network 120 may share the same smart contract. Alternatively or additionally, the smart contract may be recorded in one block of the blockchain managed by the blockchain network 120. The smart contract may be and/or may include a document and/or a script written in a programming language (e.g., Solidity or the like) and may be and/or may include a program and/or an application operating on a virtual machine executed by at least one node 120a to 120h included in the blockchain network 120. The smart contact may be written (e.g., configured) to perform a specific operation when a specific condition is satisfied. In an embodiment, the specific condition may be a condition of inputting, for example, a specific type of token or a specific format of file. Alternatively or additionally, the specific operation may be an operation of, for example, transmitting a specific type of token to a predetermined node of the blockchain network 120.

The plurality of nodes 120a to 120h may be and/or may include full nodes, light nodes, master nodes, mining nodes, random nodes, baking nodes, and/or super nodes according to operations performed by the nodes. The plurality of nodes 120a to 120h may generate the token (e.g., the asset token and/or the token for the right of use) and/or record the usage log by interacting with the platform operation server 110.

The plurality of nodes 120a to 120h may be implemented as computing devices. For example, the computing device may be and/or may include a desktop, a laptop, an application server, a proxy server, a cloud server, or the like. However, the present disclosure is not limited thereto and the computing device may include other types of devices including a computing function.

The one or more user terminals 130 may be and/or may include terminals of users using the platform for trading the digital asset based on the non-fungible token. For example, the one or more user terminals 130 may be terminals of owners of the digital asset and/or terminals of people having the right of use of the digital asset. In order to allow individual users to use the transaction platform of the digital asset, a web browser or a dedicated application may be installed in the one or more user terminals 130. The one or more user terminals 130 may be and/or may include, for example, a computing devices, such as, but not limited to, a desktop, a workstation, a laptop, a tablet computer, a wearable device, a smartphone, and the like. However, the present disclosure is not limited in this regard and the one or more user terminals 130 may include other types of computing devices having a computing function.

The platform operation server 110, the plurality of nodes 120a to 120h, and the one or more user terminals 130 may communicate through the network 140. The network 140 may be implemented as a wired and/or wireless networks, such as, but not limited to, a local area network (LAN), a wide area network (WAN), a mobile communication network (mobile radio communication network), a wireless broadband Internet (WiBro), and the like.

In an embodiment, the platform operation server 110, the plurality of nodes 120a to 120h, and the one or more user terminals 130 may indicate functionally separated elements. That is, two or more elements may be implemented in an integrated form in a real physical environment. For example, the platform operation server 110 and one of the plurality of nodes 120a to 120h may be implemented in the form of different logics within the same computing device. That is, the platform operation server 110 may be implemented to operate as at least one the plurality of nodes 120a to 120h of the blockchain network 120.

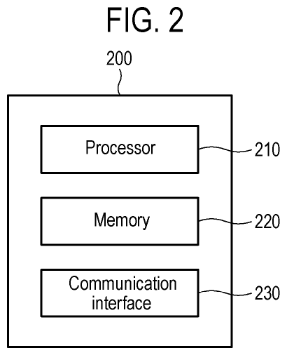

FIG. 2 illustrates a computing device 200 which may implement a device according to an embodiment of the present disclosure. In the present disclosure, the computing device 200 may be expressed as an electronic device, and the computing device 200 and the electronic device may be interchangeably used. In an embodiment, the platform operation server 110, the plurality of nodes 120a to 120h, and the one or more user terminals 130 may be implemented by using a computing device 200. The computing device 200 may include one or more processors 210 and one or more memories 220. In an embodiment, some elements may be deleted from the computing device 200 and/or other elements (e.g., a display and the like) may be added to the computing device 200. Additionally or alternatively, some elements may be integrated and/or implemented as a single entity or a plurality of entities. In the present disclosure, one or more processors 210 may be expressed as the processor 210. That is, the processor 210 may refer to a set of one or more processors unless clearly expressed differently in the context. In the present disclosure, one or more memories 220 may be expressed as the memory 220. That is, the memory 220 may refer to a set of one or more memories unless clearly expressed differently in the context.

At least some elements within the computing device 200 may be connected to each other through a bus, such as, but not limited to, general purpose input/output (GPIO), a serial peripheral interface (SPI), a mobile industry processor interface (MIPI), or the like and exchange data or signals.

The processor 210 may perform calculations and/or data processing about the control or communication of respective elements of the computing device 200. For example, the processor 210 may control at least one element of the computing device 200 connected to the processor 210 by executing software (e.g., an instruction, a program, or the like) received from other elements. As another example, the processor 210 may load an instruction and/or data to the memory 220, process the instruction and/or data stored in the memory 220, and store resultant data according to the processing in the memory 220. Alternatively or additionally, the processor 210 may be operatively connected to the elements of the computing device 200 and perform an operation of various calculations, processing, data generation, and processing related to the present disclosure.

In an embodiment, the memory 220 may store various data. The data stored in the memory 220 may include, but not be limited to, data acquired, processed, and/or used by at least one element of the computing device 200 and may include software (e.g., an instruction, a program, or the like). For example, the memory 220 may store instructions for the operation of the processor 210 as a computer program. The computer program may include one or more instructions causing the processor 210 to perform operations according to various embodiments of the disclosure when loaded to the memory 220. That is, the processor 210 may perform operations according to various embodiments of the present disclosure by executing the one or more instructions. Alternatively or additionally, the memory 220 may be and/or may include a volatile memory and/or a nonvolatile memory. In an embodiment, the instruction and/or program may be and/or may include software stored in the memory 220 and may include an operating system for controlling resources of the computing device 200, an application, middleware for providing an application with various functions to allow the application to use resources of the computing device 200, and the like.

In an embodiment, the computing device 200 may further include a communication interface 230. The communication interface 230 may also be referred to as a network interface. The communication interface 230 may establish a wired and/or wireless communication channel with each of the external devices (e.g., the plurality of nodes 120a to 120h) and/or each of the user terminals 130, and transmit and/or receive various data to and/or from the external device. In an embodiment, the communication interface 230 may include at least one port configured to be connected with the external device through a wired cable in order to communicate with the external device by wire. In such an embodiment, the communication interface 230 may communicate with the external device connected by wire through at least one port. In an embodiment, the communication interface 230 may include a cellular communication module and may be configured to be connected to a cellular network (e.g., third generation (3G), Long Term Evolution (LTE), fifth generation (5G), WiBro, worldwide inter-operability for microwave access (WiMax), or the like). In an embodiment, the communication interface 230 may include a short-range communication module and transmit and/or receive data to and/or from the external device through short-range communication (e.g., Wireless Fidelity (Wi-Fi), Bluetooth™, Bluetooth™ low energy (BLE), ultra-wideband (UWB), or the like). In an embodiment, the communication interface 230 may include a noncontact communication module for noncontact communication. The noncontact communication may include proximity communication technology in at least one noncontact scheme such as, but not limited to, near field communication (NFC), radio frequency identification (RFID) communication, magnetic secure transmission (MST) communication, and the like. Alternatively or additionally, the computing device 200 may implement and/or support one or more known communication protocols to communicate with the external device. That is, the scope of the present disclosure is not limited in this regard.

In an embodiment, the computing device 200 may further include a display. The display may display various screens on the basis of the control of the processor 210. For example, the display may display a reading result of the usage log recorded in the metadata of the asset token on the basis of the control of the processor 210. In an embodiment, in order to display the reading result of the usage log on the display, for example, a web browser and/or a dedicated application may be installed in the computing device 200. In an embodiment, the web browser and/or the dedicated application may be implemented to provide the user with a function of making a request for generating a token (e.g., the asset token or the token for the right of use) corresponding to the digital asset, a function of trading the digital asset, and the like through a user interface. Alternatively or additionally, the display may be and/or may include an element capable of interacting with the user, and may display various screens on the basis of the control of the processor 210 and receive a user input from the user. In an embodiment, the display may be implemented in the form of a touch sensor panel (TSP) capable of recognizing contact and/or proximity of various external objects (e.g., a finger, a stylus, and the like). The touch sensor panel may have various structures and types. That is, the present disclosure is not limited in this regard, and the present disclosure may be applied regardless of the structure and type of the touch sensor panel.

In an embodiment, the computing device 200 may further include an input device (e.g., a mouse, a keyboard, or the like). The input device may receive data to be used for the element (e.g., the processor 210) of the computing device 200 from the outside (e.g., the user) of the computing device 200.

FIG. 3, FIG. 5, FIG. 7, and FIGS. 8 to 10 illustrate non-fungible token processing methods according to an embodiment of the present disclosure. The illustrated non-fungible token processing methods may be described such that operations have a specific order, but the operations do not need to be performed necessarily in the illustrated order or in sequential order and not all operations may be performed. Alternatively or additionally, in operations of the non-fungible token processing methods illustrated in FIG. 3, FIG. 5, and FIG. 7, the entity that performs each operation is illustrated but there may be permissible variation in the entity. For example, the platform operation server 110 may be integrated with one of the plurality of nodes 120a to 120h of the blockchain network 120 to perform the operations of the platform operation server 110 and the node.

FIG. 3 is an exemplary flowchart illustrating an asset token generation method, according to an embodiment of the present disclosure. The asset token generation method illustrated in FIG. 3 relates to uploading the digital asset to the platform and generating the asset token corresponding to the digital asset by the user. The digital asset may be traded (e.g., purchased or sold, rented, and the like) on the basis of the generated asset token. The asset token may be and/or may include the non-fungible token corresponding to the digital asset in a one-to-one correspondence, and metadata of the asset token may include information indicating an owner of the digital asset. In the present disclosure, the asset token may be referred to as a first token.

As used herein, generation of the asset token may be understood as minting of the asset token. Accordingly, in connection with minting, any known technology which may not be described in the present disclosure may be applied to the present disclosure. For convenience of description, although the process of generating the asset token through the interaction between the platform operation server 110 and the first node 120a of the blockchain network 120 has been described, other additional nodes may generate the asset token by participating in the generation of the asset token. Alternatively or additionally, each of the platform operation server 110 and the first node 120a may be implemented in the form of logic within one computing device. That is, the procedure of generating the asset token may be performed by implementing the platform operation server 110 and the first node 120a as one device which is not separated.

The first user terminal 130a may transmit the digital asset to the platform operation server 110 and make a request for generating the asset token corresponding to the digital asset in operation S11. For example, the first user terminal 130a may make a request for transmitting the digital asset to the platform operation server 110 and generating the asset token. The request for generating the asset token may be understood to be substantially the same as and/or similar to the operation in which the first user terminal 130a transmits a message making a request for initiating the procedure of generating the asset token to the platform operation server 110. The first user terminal 130a may refer to a terminal used by an owner of the digital asset. Further, transmission of the digital asset may refer to an upload of the digital asset. In an embodiment, the request for generating the asset token may include at least some of information on the owner of the digital asset, information on a rental condition of the digital asset, or information on an address of the digital asset that may be transmitted from the first user terminal 130a to the platform operation server 110 as information on the digital asset. In an embodiment, as the information on the digital asset, which may be transmitted with the request for generating the asset token, is used for generating the asset token, the asset token may be generated to include at least some pieces of the information as metadata.

The platform operation server 110 may preprocess the information on the digital asset in operation S12. The preprocessing may be and/or may include an operation of extracting, processing, and/or modifying at least some of the digital asset received from the first user terminal 130a and the information on the digital asset, and then storing the same in the platform operation server 110 in order to perform the procedure of generating the asset token. That is, the preprocessing may be understood as an operation of processing the digital asset and the information on the digital asset to correspond to a generation protocol for generating the asset token. For example, the platform operation server 110 may extract some of the metadata (e.g., an extension of the digital asset, an address of the digital asset, and the like) of the received digital asset. As another example, the platform operation server 110 may extract, delete, and/or modify at least some of the received information on the digital asset. In an embodiment, the platform operation server 110 may store the received digital asset in the storage (e.g., distributed storage (e.g., IPFS), centralized storage (e.g., S3), or the like). In an optional or additional embodiment, the platform operation server 110 may perform operations of preprocessing the information on the digital asset in the form that may be needed by the generation protocol of the asset token. However, according to an embodiment, the preprocessing (operation S12) of the information on the digital asset may be omitted.

The platform operation server 110 may transmit the request for generating the asset token to the first node 120a in operation S13. The request for generating the asset token may be understood to be substantially the same as and/or similar to an operation in which the platform operation server 110 transmits a message making a request for executing a first smart contract to the first node 120a, as described below. In various embodiments, the platform operation server 110 may transmit the preprocessed information on the digital asset to the first node 120a, accompanied with the request for generating the asset token.

The first node 120a may generate the asset token on the basis of the information on the digital asset and the first smart contract in operation S14. The smart contract may be and/or may include a program and/or an application executed in the blockchain network 120 and may be executed in a distributed computing scheme by one or more nodes 120a to 120h included in the blockchain network 120. The smart contract may program in advance a predetermined condition and may include a code for executing a preset operation when the condition is satisfied. The first smart contract may be and/or may include a smart contract implemented in a code for generating the asset token. For example, the first smart contract may be implemented with reference to a generation protocol of a non-fungible token, such as, but not limited to, ERC-721 or ERC-1155.

In an embodiment, the first smart contract may be written to record information (hereinafter, referred to as a “usage log”) indicating a history of using the digital asset corresponding to the asset token in metadata of the asset token. In an embodiment, the usage log may be cumulatively recorded in a webpage of a link included in the metadata of the asset token on the basis of the first smart contract. That is, the usage log of the digital asset corresponding to the asset token may be cumulatively recorded in the metadata of the asset token generated on the basis of the first smart contract. In another embodiment, the first smart contract may include information for generating a token for the right of use. Metadata of the token for the right of use may include, for example, information indicating a person having the right of use of the digital asset (e.g., a user borrowing the digital asset, a user subleasing the digital asset, or the like). The person having the right of use of the digital asset may prove their own right of use by using the token for the right of use. Information for generating the token for the right of use may include, for example, information for performing the procedure of generating the token for the right of use according to the rental request for the digital asset or information on the price required for renting the digital asset.

In another embodiment, when the token for the right of use is generated according to the information for generating the token for the right of use, the first smart contract may be written to record generation information of the token for the right of use in metadata of the asset token. In an embodiment, the generation information may be cumulatively recorded in the webpage of the link (e.g., a URL linked to an external webpage) included in the metadata of the asset token on the basis of the first smart contract. That is, the generation information may be cumulatively recorded in the metadata of the asset token generated on the basis of the first smart contract according to the generation of the token for the right of use. For example, the generation information of the token for the right of use may be recorded in the asset token whenever the token for the right of use is generated. The generation information of the token for the right of use may include various pieces of information such as, but not limited to, information on a rental period of the digital asset, information on a person having the right of use of the digital asset, information on content scheduled to use the digital asset, information on an aspect scheduled to use the digital asset, or information on a time point at which the digital asset is scheduled to be used may be recorded in the form of a character string or an image as the generation information of the token for the right of use. In another example, the generation information may be and/or may include information indicating that the token for the right of use has been generated and/or information indicating the number of generations of the token for the right of use. For example, when a first token for the right of use is generated, generation information may have a value of one (1) and, thereafter, may be changed to have an accumulated value whenever the token for the right of use is generated.

The rental of the digital asset, according to the present disclosure, may be based on the token for the right of use, and thus, the generation information of the token for the right of use may be and/or may include information indicating a history of renting the digital asset. Accordingly, as the token for the right of use is generated according to the rental of the digital asset and information on the generation is cumulatively recorded in metadata of the asset token as the generation information, the value of the asset token securing the digital asset may increase.

In another embodiment, the first smart contract may include information on an incentive for the records of the usage log. An operation of recording the usage log in the metadata of the asset token may incur fees (e.g., gas) according to execution of the smart contract, and thus, it may be possible to induce recording of the usage log by assigning an incentive for recording the usage log. Assigning the incentive may be and/or may include, for example, an operation of transmitting some of the prices for renting to a wallet address of the user recording the usage log. However, the scope of the present disclosure is not limited thereto and other operations for inducing the recording of the usage log may be included in the scope of the present disclosure.

The first node 120a may transmit a generation notification of the asset token to the platform operation server 110 in operation S15. The platform operation server 110 may transmit the generation notification of the asset token to the first user terminal 130a in operation S16. The processes of operations S15 and S16 of transmitting the generation notification may be performed by various known technologies and/or techniques, and the operations for notifying generation of the asset token may be included in the scope of the present disclosure. According to an embodiment, at least some of the processes of operations S15 and S16 of transmitting the generation notification may be omitted.

In an embodiment, accompanied with one of the processes of operations S15 and S16 of notifying the generation of the asset token, the generated asset token may be transmitted to a wallet address of an owner of the digital asset using the first user terminal 130a. In an optional or additional embodiment, the generated asset token may be transmitted to a wallet address of the platform operation server 110. In another optional or additional embodiment, the generated asset token may be transmitted to the wallet address of the owner of the digital asset using the first user terminal 130a and/or the wallet address of the platform operation server 110 regardless of whether the transmission of operations S15 and S16 of the generation notification may not have been performed. For example, the generated asset token may be transmitted to the wallet address of the owner of the digital asset using the first user terminal 130a and/or the wallet address of the platform operation server 110 according to generation of the asset token in operation S14 even though the transmission optional or additional S15 and S16 of the generation notification may have been omitted.

FIG. 4 illustrates metadata of an asset token according to an embodiment of the present disclosure. Referring to FIG. 4, metadata 400 of the asset token may include attribute information 410. The attribute information 410 may include at least some pieces of information on an identifier of the asset token (e.g., Token ID attribute of FIG. 4), a URI and/or URL address of the digital asset, an address of storage (e.g., File URI attribute of FIG. 4, such as, for example, IPFS) storing the digital asset, an owner of the digital asset (e.g., Owner attribute of FIG. 4), a price required for renting the digital asset (e.g., Asset Permission Price attribute of FIG. 4), whether the digital asset may and/or is allowed to be subleased (e.g., Binded attribute of FIG. 4), and accumulated profits according to the rental of the digital asset (e.g., Total Profit attribute of FIG. 4). However, the present disclosure is not limited in this regard, and the attribute information 410 may further include other information which may express attributes of the digital asset.

In an embodiment, the metadata 400 of the asset token may further include generation information of the token for the right of use. Generation of the token for the right of use (e.g., generation information recorded according to renting of the digital asset) may configure independent heritage for the digital asset. Alternatively or additionally, the metadata 400 of the asset token may include one or more usage logs 420. The usage logs 420 may be accumulated and recorded in the metadata 400 of the asset token according to the use of the digital asset corresponding to the metadata 400 of the asset token. In an embodiment, the usage logs 420 recorded in the metadata 400 may be recorded in the form of a URL linked to an external webpage in which the usage logs are recorded. In such an embodiment, the input usage logs may be identified through access to the URL according to the usage logs 420 recorded in the metadata 400 of the asset token. The one or more recorded usage logs 420 may configure independent heritage for the digital asset.

In an embodiment, a representative image of the asset token may be determined as one of a plurality of sub digital assets included in the digital asset on the basis of generation information of the token for the right of use recorded in the metadata of the asset token or the number of usage logs. For example, the representative image of the asset token may be determined on the basis of the number of pieces of generation information of the token for the right of use related to the asset token and/or may be determined on the basis of the number of usage logs related to the asset token. In another example, the representative image of the asset token may be determined on the basis of a sum and/or a weighted sum of the number of pieces of generation information of the token for the right of use related to the asset token and the number of usage logs related to the asset token. The plurality of sub digital assets may be and/or may include a plurality of lower digital assets that may be grouped into one digital asset having common attributes. For example, when a portrait of a person is the digital asset, a sub digital asset of the portrait may include a portrait in the person's childhood, a portrait in the person's adolescence, a portrait in the person's manhood, and a portrait in the person's senescence. As another example, when a chair image is the digital asset, a sub digital asset of the chair image may include a chair image in new condition, a stained chair image, and an old chair image. As yet another example, when an image is the digital asset, a sub digital asset of the image may include a plurality of images in which at least some of the images are deformed. Such a deformation may refer to possible deformations of the original image, such as, but not limited to, addition and/or change of the shape, a change in the color, movement of locations of some pixels, and the like. Alternatively or additionally, the representative image may be and/or may include an image indicating the asset token, and the representative image may be changed to one of the sub digital assets according to a predetermined condition (e.g., generation information of the token for the right of use, the number of usage logs, or the like). In order to determine the representative image, technologies related to a dynamic non-fungible token (NFT) may be referenced. It may be possible to diversely indicate the asset token by changing the representative image of the asset token according to the generation information of the token for the right of use or the number of usage logs and, accordingly, further increase the value of the asset token. For example, a portrait of a person may be changed from a portrait in the person's childhood to a portrait in the person's senescence according to the generation of the token for the right of use or the number of usage logs. As another example, as the generation information of the token for the right of use or the number of usage logs increases, a representative image of a chair may be changed from an image of a new chair to an image of a gradually older chair.

In another embodiment, a representative image of the asset token may be determined as one of a plurality of sub digital assets included in the digital asset on the basis of a weighted sum of the number of pieces of generation information recorded in the metadata of the asset token and a rental period corresponding to the generation information. For example, when a rental period of first generation information is one week and a rental period of second generation information is one day, a first weighted value applied to the first generation information may be set to be larger than a second weighted value applied to second generation information. Accordingly, even when two pieces of generation information are recorded for a “token A” and a “token B,” a representative image of a token having a larger sum of rental periods may be changed more quickly. According to the embodiment, the representative image of the asset token may be changed in consideration of not only the number of pieces of generation information but also a rental period corresponding to the generation information. That is, it may be possible to change the representative image of the asset token in consideration of a time of rental as well as the number of rentals of the digital asset.

In another embodiment, the representative image of the asset token may be determined as one of a plurality of sub digital assets included in the digital asset on the basis of a weighted sum of the number of usage logs recorded in the metadata of the asset token and a period of use corresponding to the usage log. The period of use may be a period during which the digital asset corresponding to the usage log is used. For example, when a rental period of the digital asset is one month and a period of use during which the digital asset is used for specific content is one week, it may be understood that the digital asset may be rented for a total of one month and may be used for specific content for one week within the rental period. That is, according to the example, the period of use corresponding to the usage log may be one week. In an example of the weighted sum, when a period of use of a first usage log is one week and a period of use of a second usage log is one day, a first weighted value applied to the first usage log may be configured to be larger than a second weighted value applied to the second usage log. Accordingly, even when two usage logs are recorded for the “token A” and the “token B,” a representative image of a token having a larger sum of periods of use may be changed more quickly. According to the embodiment, the representative image of the asset token may be changed in consideration of only the number of usage logs but also the period of use corresponding to each usage log. That is, it may be possible to change the representative image of the asset token in consideration of a time of use as well as the number of uses of the digital asset.

In another embodiment, the representative image of the digital token may be determined as one of a plurality of sub digital assets included in the digital asset on the basis of whether the usage log (or generation information of the token for the right of use) recorded in the metadata of the asset token is satisfied with a specific condition. For example, when the usage log (and/or the generation information) recorded in the metadata of the asset token is satisfied with the specific condition to calculate the number of usage logs (and/or the generation information) in order to determine the representative image of the asset token, the number of usage logs (and/or generation information) may be calculated by assigning weighted values to the usage logs (and/or generation information). Alternatively or additionally, when the usage log (and/or generation information) recorded in the metadata of the asset token is satisfied with the specific condition to determine the representative image of the asset token, a sub digital asset corresponding to the specific condition may be determined as the representative image.

The specific condition may be and/or may include condition related to information on an owner of the digital asset or a person having the right of use, who uses the digital asset. For example, the specific condition may be and/or may include a condition that a person belonging to a “group A” (e.g., 100 people of the year or the like) is recorded in the usage log by using the digital asset. When there is a usage log in which the person belonging to the “group A” uses the digital asset as the owner or the person having the right of use among the usage logs, the usage log may acquire a weighted value to calculate the number of usage logs, or a sub digital asset (e.g., a sub digital asset associated with the “group A”) corresponding to the specific condition (the condition that the person belonging to the “group A” is recorded in the usage log by using the digital asset) may be determined as the representative image. As another example, the specific condition may be and/or may include a condition that the person belonging to the “group A” rents the digital asset and generation information of the token for the right of use is recorded.

The specific condition may be and/or may include a condition related to information on content using the digital asset. For example, the specific condition may be and/or may include a condition that the digital asset is used for content belonging to the “group B” (e.g., a movie nominated as a candidate for a film festival) and recorded in the usage log. When there is a usage log using the digital asset in content belonging to the “group B” among the usage logs, the usage log may acquire a weighted value to calculate the number of usage logs, or a sub digital asset (e.g., a sub digital asset associated with the “group B”) corresponding to the specific condition (e.g., a condition that the digital asset is used for the content belonging to the “group B” and recorded in the usage log) may be determined as the representative image. As another example, the specific condition may be a condition that the content belonging to the “group B” is scheduled to use the digital asset and recorded in generation information.

Other specific conditions may be and/or may include a condition related to information on the usage aspect of the digital asset (e.g., a condition that the digital asset is used for a specific type of content (e.g., a movie, a soap opera, a game, an audio clip, or the like) and recorded in the usage log (and/or generation information)) and/or a condition related to information on a time point at which the digital asset is used (e.g., a condition that the digital asset is used and recorded in the usage log (or generation information) until a specific date). The specific conditions may be and/or may include conditions obtained by combining at least some of the conditions.

In connection with an embodiment, information for determining whether the specific conditions are satisfied may be stored in advance in the memory 220 of the platform operation server 110. Alternatively or additionally, the platform operation server 110 may receive the information for determining whether the specific conditions are satisfied from an external database. In an embodiment, the information for determining whether the specific conditions are satisfied may be stored in advance in the external database. For example, the information for determining whether the specific conditions are satisfied may include at least some pieces of information on people belonging to the “group A,” information on content belonging to the “group B,” information on a specific type of content, and/or information on a specific date.

FIG. 5 is an exemplary flowchart illustrating a method of generating a token for the right of use according to an embodiment of the present disclosure. The method of generating the token for the right of use according to an embodiment relates to generation of the token for the right of use for the digital asset in order to rent the digital asset uploaded to the platform. The token for the right of use may be and/or may include a non-fungible token corresponding to a request for renting the digital asset in a one-to-one correspondence. In an embodiment, the token for the right of use may include renting information (e.g., information on a person having the right of use of the digital asset, information on a rental period, and the like). In the present disclosure, the token for the right of use may be expressed as a second token. Generation of the token for the right of use may be understood as minting of the token for the right of use.

Although the operation of generating the token for the right of use through interaction between the platform operation server 110 and the second node 120b of the blockchain network is described, other additional nodes may be involved in generation of the token for the right of use to generate the token for the right of use. Alternatively or additionally, the platform operation server 110 and the second node 120b may be implemented in the form of different logics within the same computing device. That is, the procedure of generating the token for the right of use may be performed by implementing the platform operation server 110 and the second node 120b as one device which is not separated.

The second user terminal 130b may transmit a rental request to the platform operation server 110 in operation S21. The second user terminal 130b may be and/or may include a terminal used by a user who desires to rent the digital asset. The rental request may be understood to be substantially the same as and/or similar to an operation in which the second user terminal 130b transmits a message making a request for initiating the procedure of renting the digital asset to the platform operation server 110. The rental request may include, but not be limited to, at least some pieces of information on the user making the rental request, information on a rental period, information on the purpose of the digital asset scheduled to be used (e.g., content scheduled to be used, a scheduled usage aspect, a time point at which the digital asset is scheduled to be used, or the like), or information on the digital asset subject requested to be rented that may be transmitted from the second user terminal 130b to the platform operation server 110 as information on the rental request. In an embodiment, as the information on the rental request transmitted with the rental request is used for generating the token for the right of use, the token for the right of use may be generated to include at least some pieces of the information as metadata. Alternatively or additionally, the rental request may include a virtual asset for paying the price for rental of the digital asset that may be transferred from a wallet address of the user using the second user terminal 130b to a wallet address of the platform operation server 110.

The platform operation server 110 may preprocess information on the rental request in operation S22. The preprocessing may be and/or may include an operation of extracting, processing, and/or modifying at least some pieces of the information on the rental request received from the second user terminal 130b and then storing the same in the platform operation server 110 in order to perform the procedure of generating the token for the right of use. That is, the preprocessing may be understood as an operation of processing the information on the rental request to correspond to a generation protocol for generating the token for the right of use. For example, the platform operation server 110 may extract, delete, and/or modify at least some pieces of the information on the rental request. Alternatively or additionally, the platform operation server 110 may perform various operations of preprocessing the information on the rental request and may perform operations of preprocessing the information on the rental request in a form conforming to the generation protocol of the token for the right of use. However, according to an embodiment, the preprocessing (operation S22) of the information on the rental request may be omitted.

The platform operation server 110 may transmit the request for generating the token for the right of use to the second node 120b in operation S23. The request for generating the token for the right of use may be understood to be substantially the same as and/or similar to an operation in which the platform operation server 110 transmits a message requesting execution of a second smart contract to the second node 120b, as described below. In various embodiments, accompanied with the request for generating the token for the right of use, the platform operation server 110 may transmit information on the preprocessed rental request to the second node 120b.

In an embodiment, the subject of the request for generating the token for the right of use may be the node executing the first smart contract, rather than the platform operation server 110. For example, the platform operation server 110 may execute the first smart contract with a specific node included in the blockchain network by using information on the processed rental request, and the specific node executing the first smart contract may transmit the request for generating the token for the right of use to the second node 120b on the basis of the information for generating the token for the right of use included in the first smart contract. That is, one or more nodes may be included between the platform operation server 110 and the second node 120b to execute the second smart contract related to generation of the token for the right of use in association with the first smart contract related to generation of asset token.

The second node 120b may determine whether to generate the token for the right of use according to the first smart contract in S24. That is, the second node 120b may determine whether to generate the token for the right of use on the basis of the information for generating the token for the right of use included in the first smart contract. For example, whether to generate the token for the right of use may be determined by comparing the virtual asset accompanying the rental request and information on the price of rental of the digital asset included in the first smart contract. Whether to generate the token for the right of use may be determined by comparing information on the rental condition included in the first smart contract and the information accompanying the rental request in addition to the above-described examples.

The second node 120b may generate the token for the right of use on the basis of the information on the rental request and the second smart contract in operation S25. The second smart contract may be a smart contract implemented in a code for generating the token for the right of use. For example, the second smart contract may be implemented with reference to a generation protocol of a non-fungible token, such as, but not limited to, ERC-721 or ERC-1155.

In an embodiment, when the token for the right of use is generated, generation information of the token for the right of use may be recorded in metadata of the asset token. According to association between the first smart contract and the second smart contact, generation information of the token for the right of use may be recorded in the metadata of the asset token. Accordingly, information on the generation information within attribute information of the metadata of the asset token may be cumulatively recorded.

In another embodiment, when the token for the right of use is generated, the amount of the virtual assets accompanying the rental request may be cumulatively recorded in the metadata of the asset token. According to association between the first smart contract and the second smart contact, the amount of virtual assets accompanying the rental request may be cumulatively recorded in the metadata of the asset token. Accordingly, information on accumulated profits within attribute information of the metadata of the asset token may be updated.

According to generation of the token for the right of use, the second node 120b may transmit a generation notification of the token for the right of use to the platform operation server 110 in S26. The platform operation server 110 may transmit the generation notification of the asset token to the second user terminal 130b in operation S27. Various known technologies and/or techniques may be referenced for transmission of the notification, and operations for notifying generation of the token for the right of use may be included in the scope of the present disclosure. Further, according to an embodiment, the processes of operations S26 and S27 of transmitting the generation notification may be omitted.

In an embodiment, accompanied with one of the processes of operations S26 and S27 of transmitting the asset token generation notification, the generated token for the right of use may be transmitted to the wallet address of the person having the right of use of the digital asset using the second user terminal 130b. In an optional or additional embodiment, the generated token for the right of use may also be transmitted to the wallet address of the platform operation server 110. In another optional or additional embodiment, the generated token for the right of use may be transmitted to the wallet address of the user using the second user terminal 130b and/or the wallet address of the platform operation server 110 regardless of whether the processes of operations S26 and S27 of transmitting the asset token generation notification have been performed. For example, the generated token for the right of use may be transmitted to the wallet address of the user using the second user terminal 130b and/or the wallet address of the platform operation server 110 according to generation of the asset token in S25 even though the processes S26 and S27 of transmitting the asset token generation notification may have been omitted.

FIG. 6 illustrates metadata of the token for the right of use according to an embodiment of the present disclosure. Referring to FIG. 6, metadata 600 of the token for the right of use may include attribute information 610. The attribute information 610 may include at least some pieces of information on an identifier of the token for the right of use (e.g., Permission Token ID attribute of FIG. 6), an identifier of the asset token corresponding to the token for the right of use (e.g., Token ID attribute of FIG. 6), a person having the right of use of the digital asset (e.g., Owner attribute of FIG. 6), a history of using the digital asset (e.g., Used At attribute of FIG. 6), and whether the digital asset may be subleased (e.g., Binded attribute of FIG. 6). However, in addition to the above-described information which may be included in the attribute information 610, information which may express attributes of the right of use of the digital asset may be further included. In an embodiment, usage logs may be recorded in the asset token on the basis of information on the history of using the digital asset recorded in the metadata 600 of the token for the right of use. That is, although the person having the right of use may not directly input the usage logs in the asset token, the usage logs may be recorded in the asset token with reference to the metadata 600 of the token for the right of use.

In an embodiment, the metadata of the token for the right of use may include information indicating a rental period of the digital asset. Since the token for the right of use may provide proof that proves the right of use of the digital asset, it may be impossible to prove the right of use according to expiration of the rental period. Further, since the token for the right of use may be transferred, it may be impossible to transfer the token for the right of use according to expiration of the rental period. Alternatively or additionally, it may be impossible to record the usage logs in the asset token and/or the token for the right of use according to expiration of the rental period.

In an embodiment, the metadata of the token for the right of use may include information indicating whether the digital asset may be subleased. The information indicating whether the digital asset may be subleased may be included in the metadata of the token for the right of use in a Boolean form (e.g., Binded attribute of FIG. 6). For example, the token for the right of use indicated to be subleased may be uploaded to the platform by the person having the right of use and freely traded with another user. As another example, the token for the right of use indicated as being impossible to sublease may not be traded. The configuration indicating whether the sublease is possible or not may be implemented by being inserted into the second smart contract generating the token for the right of use or implemented by being inserted into the first smart contract generating the token for the right of use in association with the second smart contract.

FIG. 7 is an exemplary flowchart illustrating a usage log recording method according to an embodiment of the content disclosure in the present disclosure. The usage log recording method according to an embodiment may be a method of recording the usage log in the asset token corresponding to the digital asset. The person having the right of use of the digital asset may be a person indicated as the person having the right of use in the token for the right of use. In an embodiment, the owner of the digital asset may record the usage log in the asset token. In such an embodiment, fees (e.g., gas) generated for recording the usage log may be imposed on the owner. Hereinafter, the usage log recording method may be described on the basis of interaction between the platform operation server 110 and the third node 120c of the blockchain network, but other additional nodes may be involved in recording of the usage log.

The third user terminal 130c may transmit the usage log to the platform operation server 110 in operation S31. The third user terminal 130c may be and/or may include a terminal used by the person having the right of use of the digital asset and/or a terminal used by the owner of the digital asset. As used herein, the transmission of the usage log may refer to an upload of the usage log. In an embodiment, information uploaded to the platform operation server 110 as the usage log may be and/or may include a character string and/or an image.

The platform operation server 110 may transmit a request for recording the usage log to the third node 120c in operation S32. For example, the platform operation server 110 may transmit the request for recording the usage log to the third node 120c by executing the first smart contract related to the asset token. The request for recording the usage log may be understood to be substantially the same as and/or similar to the operation in which the platform operation server 110 transmits the message making a request for initiating the procedure of recording the usage log to the third node 120c.

The third node 120c may record the usage log in operation S33. Specifically, the third node 120c may record the usage log in the metadata of the asset token by executing the first smart contract related to the asset token. The operation of the third node 120c may be understood as an operation of recording the received usage log in a webpage of a link included in the metadata of the asset token as a result of the operation S31 of transmitting the usage log.

In an embodiment, the usage log may be recorded in the metadata of the asset token on the basis of whether a time point at which the digital asset indicated by the usage log is used is within a rental period of the digital asset. That is, the use after the rental period corresponds to the unauthorized use of the digital asset, and thus, the use may not be recorded in the metadata of the asset token as the usage log.

In an embodiment, the usage log may be recorded in the metadata of the asset token on the basis of whether a time point at which the request for recording the usage log is transmitted is within the rental period of the digital asset. For example, recording of the usage log requested to be recorded after expiration of the rental period may be deactivated by using information on the rental period included in the metadata of the token for the right of use as a requirement of recording of the usage log.

In an embodiment, the usage log may be recorded in the metadata of the asset token on the basis of whether a time point at which the request for recording the usage log is transmitted is within a usage log recording period determined according to the rental period of the digital asset. The usage log recording period may refer to a period that may be determined according to the rental period, and that may be a period periodically and/or aperiodically determined within the rental period and/or a predetermined period after expiration of the rental period.

In an embodiment, when the person having the right of use of the digital asset is verified according to a verification operation described below, information using the digital asset may be recorded in the metadata of the asset token as the usage log. In such an embodiment, the subject of recording the usage log may be a user using an external terminal transmitting a verification request. The external terminal may be and/or may include a terminal related to the subject directly using the digital asset (e.g., a film company, a game company, or the like). In an embodiment, fees according to recording of the usage log may be imposed on the external terminal as the price of verification. As the usage log is recorded by the subject directly using the digital asset, reliability of the usage log may be secured.

In an embodiment, at least some of the virtual assets accompanying the request for renting the digital asset may be transmitted to the wallet address of the person having the right of use in response to the request for recording the usage log from the person having the right of use.

The third node 120c may transmit a use log recording notification to the platform operation server 110 in operation S34. The platform operation server 110 may transmit the usage log recording notification to the third user terminal 130c in operation S35. Various known technologies may be referenced for transmission of the notification, and operations for notifying recording of the usage log may be included in the scope of the present disclosure. Further, according to an embodiment, the processes of operations S34 and S35 of transmitting the usage log recording notification may be omitted.

FIGS. 8 to 10 illustrate non-fungible token processing methods, according to an embodiment of the present disclosure. The methods may perform additional operations according to the first smart contract and/or the second smart contract. Operations of the methods may be implemented by one or more instructions executed by the processor of the computing device (e.g., computing device 200). Respective operations included in the methods may be performed by one physical computing device, but first operations of the methods may be performed by a first computing device and second operations of the methods may be performed by a second computing device. Hereinafter, in description of FIGS. 8 to 10, it may be assumed that the operations of the methods are performed by one of the plurality of nodes 120a to 120h of the blockchain network 120.

FIG. 8 is a flowchart illustrating a method of withdrawing virtual assets through asset tokens according to an embodiment of the present disclosure. Withdrawal of virtual assets through the asset tokens may be performed as the first smart contract corresponding to the asset tokens is executed by the node.

In response to a request for withdrawing the asset tokens, at least some of the virtual assets recorded in metadata of the asset tokens may be transmitted to the wallet address of the owner of the asset tokens on the basis of rental of the digital assets in block S100. The withdrawal request may be and/or may include a message of a request received by the node executing the first smart contract. For example, the withdrawal request may be transmitted directly by the user terminal 130 and/or may be transmitted via the platform operation server 110. A withdrawal operation may be implemented on the basis of a withdrawal function defined in the first smart contract according to the withdrawal request. As described above, the owner of the asset tokens may create profits by renting digital assets corresponding to the asset tokens.

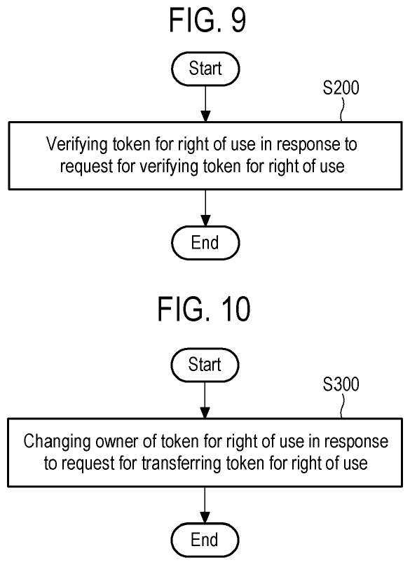

FIG. 9 is a flowchart illustrating a token for the right of use verification method according to an embodiment of the present disclosure. Verification of the token for the right of use may be performed by searching for a block in which the token for the right of use is recorded without any consumption of transactions.

In response to a request for verifying the token for the right of use from an external terminal, the token for the right of use may be verified in block S200. The verification request may be and/or may include a message of a request for verifying authenticity of the right of use by searching for the block in which the token for the right of use is recorded. For example, the verification request may be transmitted directly to the node from the external terminal and/or may be transmitted to the node via the platform operation server 110. Further, as the node, the platform operation server 110 may receive the verification request from the external terminal and verify the token for the right of use.

For example, in response to the request for verifying the token for the right of use, at least some of the nodes 120a to 120h in the blockchain network may compare metadata of the token for the right of use subject to the verification request with information recorded in the block corresponding to the token for the right of use. It may be determined that the token for the right of use has no abnormality and/or defect when the metadata is the same as (e.g., matches) the information recorded in the block on the basis of the comparison result. Alternatively or additionally, it may be determined that the token for the right of use has an abnormality and/or defect when the metadata is not the same as the information recorded in the block. When there is no abnormality or defect on the basis of the verification result of the token for the right of use, at least one of the nodes 120a to 120h in the blockchain network 120 may transmit at least some of an address of the asset token, an address of the token for the right of use, an identifier of the token for the right of use, a signature of the person having the right of use, and/or a temporary value to the external terminal transmitting the verification request. For example, the information may be transmitted to the subject directly using the digital assets (e.g., a film company, a game company, or the like) according to the second smart contract. That is, the external terminal may receive the above-described information as the result of passing through the verification for the token for the right of use. The temporary value may be a value that may be randomly changed whenever the verification request is made. As such, it may be understood that the temporary value may be used as a value for preventing relay attack that abuses the signature of the person having the right of use. Accordingly, it may be possible to secure reliability of the use of the digital asset by verifying the right of use of the digital asset using the token for the right of use.

In an embodiment, an asymmetric key encryption algorithm using a public key and a private key may be applied to the block S200 related to the verification request. For example, in response to the verification request for the token for the right of use, the user terminal of the person having the right of use may encrypt an address of the asset token, an address of the token for the right of use, or an identifier of the token for the right of use by the private key to perform electronic signature (e.g., signature of the person having the right of use). The user terminal 130 of the person having the right of use may transmit the electronically signed information to at least some of the nodes 120a to 120h in the blockchain network 120. At least some of the nodes 120a to 120h in the blockchain network 120 may transmit the address of the asset token, the address of the token for the right of use, the identifier of the token for the right of use, the signature of the person having the right of use, and/or the temporary value to the external terminal transmitting the verification request according to the second smart contract. The external terminal receiving the information may decrypt the electrically signed information by the public key of the person having the right of use and compare the decrypted information with information recorded in the block corresponding to the token for the right of use. It may be determined that the token for the right of use has been verified when the decrypted information is the same as (e.g., matches) the recorded information. Alternatively or additionally, it may be determined that the token for the right of use has not been verified when the decrypted information is not the same as the recorded information.

FIG. 10 is a flowchart illustrating a token for the right of use transfer method according to an embodiment of the present disclosure. Transferring the token for the right of use may be and/or may include subleasing the token for the right of use to another person by the person having the right of use. The transfer of the token for the right of use may be performed as the second smart contract corresponding to the token for the right of use is executed by the node.

In response to a request for transferring the token for the right of use, an owner of the token for the right of use may be changed in block S300. The transfer request may be and/or may include a message of a request received by the node executing the second smart contract and may be transmitted, for example, directly by the user terminal and/or transmitted via the platform operation server 110. For example, information indicating the person having the right of use included in metadata of the token for the right of use may be changed, and/or information indicated by the Owner attribute illustrated in FIG. 6 may be changed. As the transfer of the token for the right of use becomes possible, the use of the digital assets may be activated.

In an embodiment, the node executing the second smart contract related to the token for the right of use may change information indicating the person having the right of use included in the metadata of the token for the right of use on the basis of information on a rental period included in the metadata of the token for the right of use. For example, before the rental period of the token for the right of use expires, the transfer of the token for the right of use may become possible as a function of transferring ownership of the second smart contract is activated. For example, when the rental period of the token for the right of use expires, the transfer of the token for the right of use may become impossible as a function of transferring ownership of the second smart contract may be deactivated.

In the present disclosure, it may be possible to increase a value of asset tokens guaranteeing digital assets by recording a history of using the digital assets in metadata of the asset tokens guaranteeing the digital assets. Alternatively or additionally, as a platform for trading the digital assets is provided to users, it may be possible to increase the use of the digital assets. The effects according to the technical idea of the present disclosure may not be limited to the above-mentioned effects, and other effects which may not be mentioned may be clearly understood by those skilled in the art from the description of the present disclosure.

In the flowchart according to the present disclosure, respective operations of the method or the algorithm are sequentially described, but the respective operations may be performed according to an order of random combinations as well as sequential performance. The description of the flowchart of the present disclosure may not exclude changes and/or modifications in the method and/or the algorithm and may not indicate that a random operation is necessary and/or preferable. In an embodiment, at least some operations may be performed in parallel, repeatedly, and/or heuristically. In an embodiment, at least some operations may be omitted or other operations may be added.

According to at least one embodiment disclosed in the present disclosure, a value of the non-fungible token guaranteeing the digital asset may be increased.

According to at least one embodiment disclosed in the present disclosure, a history of using the digital asset may be indicated as the non-fungible token guaranteeing the digital asset.

According to at least one embodiment disclosed in the present disclosure, the use of the digital asset may be increased by providing a platform through which the digital asset may be leased.

According to at least one embodiment disclosed in the present disclosure, a technology for proving the right of use according to rental of the digital asset may be provided.

Various embodiments according to the present disclosure may be implemented as software in a machine-readable storage medium. The software may be software for implementing various embodiments disclosed in the present disclosure. The software may be inferred from various embodiments disclosed in the present disclosure by programmers in the technical field to which the present disclosure belongs. For example, the software may be and/or may include a program including a machine-readable instruction (e.g., a code or a code segment). The device may be and/or may include a device capable of operating according to an instruction loaded from the storage medium, and may be, for example, a computer. In an embodiment, the device may be and/or may include a computing device according to various embodiments disclosed in the present disclosure. In an embodiment, a processor of the device may execute the loaded instruction and allow elements of the device to perform a function corresponding to the instruction. The storage medium may be and/or may include various types of recording medium storing machine-readable data. The storage medium may be and/or may include, but not be limited to, a read-only memory (ROM), a random access memory (RAM), a compact disc ROM (CD-ROM), a magnetic tape, a floppy disk, an optical data storage device, and the like. In an embodiment, the storage medium may be implemented in the form distributed to the computer systems which are connected through a network. The software may be distributed to and stored in computer systems and executed. The storage medium may be a non-transitory storage medium. The non-transitory storage medium may be a tangible medium regardless of semi-permanently and/or temporarily stored data and does not include a transitorily transmitted signal.

Although the technical idea according to the present disclosure has been described by various embodiments, the technical idea according to the present disclosure may include various replacements, modifications, and changes that may be made within the scope of understanding by those skilled in the art. Further, the replacements, modifications, and changes should be understood as being included in the scope of the accompanying claims.

What is claimed is:

1. An electronic device, comprising:
a communication interface configured to communicate with at least one node of a blockchain network and an external device;
one or more memories configured to store at least one instruction; and
one or more processors communicatively coupled to the communication interface and to the one or more memories, wherein the one or more processors are configured to execute the at least one instruction to:
receive, from a user terminal of a user, a rental request for a digital asset corresponding to a first token; and
perform a procedure of generating a second token based on the rental request;
wherein the first token is generated based on a first smart contract configured to prove ownership of the digital asset,
wherein first metadata of the first token indicates an owner having the ownership of the digital asset,
wherein the second token is generated based on a second smart contract configured to prove a right of use of the digital asset,
wherein second metadata of the second token indicates a person having the right of use of the digital asset, and
wherein generation information of the second token indicating a rental history of the digital asset is recorded in the first metadata of the first token, based on generation of the second token.

2. The electronic device of claim 1, wherein the one or more processors are further configured to:
receive, from the user terminal of the user, a usage log indicating a usage history of the digital asset; and
perform a recording procedure of recording the usage log of the first token in the first metadata of the first token, based on receiving the usage log,
wherein the recording procedure comprises an operation of transmitting, to the at least one node of the blockchain network, a recording request requesting to execute the first smart contract.

3. The electronic device of claim 2, wherein the second metadata of the second token further indicates a rental period of the digital asset, and
wherein the one or more processors are further configured to perform the recording procedure of recording the usage log of the first token based on whether a time point at which the recording request is transmitted is within the rental period.

4. The electronic device of claim 2, wherein virtual assets corresponding to at least a portion of virtual assets recorded in the first token are transmitted to a wallet address of the person having the right of use, based on the recording request.

5. The electronic device of claim 2, wherein the usage log comprises at least one of information on the person having the right of use, information on content using the digital asset, information on an aspect of using the digital asset, or information on a time point at which the digital asset is used.

6. The electronic device of claim 2, wherein the one or more processors are further configured to:
receive, from an external terminal distinguished from the user terminal, a verification request for the second token;
compare the second metadata of the second token with information recorded in a block corresponding to the second token based on the verification request; and
transmit, to the external terminal, based on the second metadata of the second token matching the information recorded in the block, at least one of a first address of the first token, a second address of the second token, an identifier of the second token, a signature of the person having the right of use, or a temporary value,
wherein the temporary value is a randomly changed value based on reception of the verification request.

7. The electronic device of claim 6, wherein, based on the second metadata of the second token matching the information recorded in the block, information indicating the usage history of the digital asset is recorded in the first metadata of the first token as the usage log.

8. The electronic device of claim 2, wherein a representative image of the first token is determined as one of a plurality of sub digital assets comprised by the digital asset, based on at least one of a first number of the usage log recorded in the first metadata of the first token or a second number of the generation information.

9. The electronic device of claim 8, wherein the representative image of the first token is determined as one of the plurality of sub digital assets comprised by the digital asset, based on at least one of a first weighted sum of the first number and a usage period corresponding to the first number or a second weighted sum of the first number and a rental period corresponding to the first number.

10. The electronic device of claim 2, wherein a representative image indicating the first token is determined as one of a plurality of sub digital assets comprised by the digital asset, based on whether at least one of the usage log recorded in the first metadata of the first token or the generation information satisfies a predetermined condition, and
wherein the predetermined condition is related to at least one of:
information on the owner or the person having the right of use of the digital asset comprised by at least one of the usage log or the generation information;
information on content related to the use of the digital asset; or
information on an aspect of using the digital asset.

11. The electronic device of claim 1, wherein the one or more processors are further configured to:
perform the procedure of generating the second token based on an interaction with the at least one node of the blockchain network.

12. The electronic device of claim 1, wherein the second metadata of the second token further indicates whether the digital asset is allowed to be subleased.

13. The electronic device of claim 1, wherein the generation information comprises at least one of information on a rental period of the digital asset, information on the person having the right of use, information on content scheduled to use the digital asset, information on an expected usage aspect of the digital asset, or information on a time point at which the digital asset is scheduled to be used.

14. The electronic device of claim 1, wherein the rental request is accompanied with an operation of transmitting, to a wallet address of the electronic device, a virtual asset corresponding to a price for rental of the digital asset, based on receiving the rental request.

15. The electronic device of claim 14, wherein the virtual asset are recorded in the first metadata of the first token, based on generation of the second token, and
wherein the one or more processors are further configured to:
receive, from a user terminal of the owner of the digital asset, a withdrawing request requesting to withdraw the virtual asset from the first token; and
transmit, to the at least one node of the blockchain network, a transmit message requesting to transmit at least a portion of the virtual asset to a wallet address of the owner, based on the withdrawing request.

16. The electronic device of claim 1, wherein the one or more processors are further configured to:
receive, from the user terminal of the user, a transfer request requesting to transfer the second token; and
transmit, to the at least one node of the blockchain network, a change message requesting to change information indicating the person having the right of use of the second token, based on the transfer request.

17. The electronic device of claim 16, wherein the second metadata of the second token further indicates a rental period of the digital asset, and
wherein the one or more processors are further configured to change information indicating the person having the right of use of the second token based on whether the rental period has lapsed.

18. The electronic device of claim 1, wherein the first smart contract comprises information for generating the second token comprising rental information of the digital asset as metadata, and
wherein the rental information of the digital asset indicates the person having the right of use of the digital asset.

19. A method performed by an electronic device, comprising:
receiving, from a user terminal of a user, a rental request for a digital asset corresponding to a first token; and
performing a procedure of generating, based on the rental request, a second token,
wherein the first token is generated based on a first smart contract configured to prove ownership of the digital asset,
wherein first metadata of the first token indicates an owner having the ownership of the digital asset,
wherein the second token is generated based on a second smart contract configured to prove a right of use of the digital asset,
wherein second metadata of the second token indicates a person having the right of use of the digital asset, and
wherein generation information of the second token indicates a rental history of the digital asset is recorded in the first metadata of the first token, based on the generating of the second token.

20. The method of claim 19, further comprising:
receiving, from the user terminal of the user, a usage log indicating a usage history of the digital asset; and
performing a recording procedure of recording the usage log of the first token in the first metadata of the first token, based on the receiving of the usage log,
wherein the recording procedure comprises an operation of transmitting, to at least one node of a blockchain network, a recording request requesting to execute the first smart contract.
